(19) United States
(12) Patent Application Publication
(10) Pub. No.: US 2025/0276811 A1
(43) Pub. Date: Sep. 4, 2025

(54) TELEMETRY VISUALIZATION SYSTEM FOR FAST DISPLAY OF AIRCRAFT DATA AND ASSOCIATED SYSTEMS AND METHODS

(71) Applicant: BOOM TECHNOLOGY, INC., Centennial, CO (US)

(72) Inventor: David Hunter, Lone Tree, CO (US)

(21) Appl. No.: 18/082,219

(22) Filed: Dec. 15, 2022

Related U.S. Application Data
(60) Provisional application No. 63/289,877, filed on Dec. 15, 2021.

(51) Int. Cl. B64F 5/60; G07C 5/00

(52) U.S. Cl. CPC B64F 5/60; G07C 5/008

(57) ABSTRACT

Systems, methods and computer-readable media for telemetry data visualization are described herein. The described system includes paths and reduced components in between reception of sensor data and display to an engineer, reducing time delays and reducing the possibilities of scenarios where telemetry does not reach the responsible engineer to monitor and respond to various situations that may arise. In particular embodiments, a communications hub allows telemetry sensor readings to be simultaneously consumed by multiple components in memory-optimized fashion.

### CROSS-REFERENCE TO RELATED APPLICATION

The present application claims priority to pending U.S. Provisional Application 63/289,877, filed on Dec. 15, 2021, and incorporated herein by reference.

### TECHNICAL FIELD

Embodiments of the described technology are directed to testing various aircraft systems using telemetry data associated with systems under test, and associated systems and methods.

### BACKGROUND

An aircraft contains a multitude of electrical systems, mechanical systems, electro-mechanical systems, computing systems, and/or other systems. These systems can include various mechanical components, electrical components, and/or computer hardware and software, such as flaps, elevators, circuits, and/or other components. Each system can also be instrumented with various sensors to measure, in real-time, system performance and limitations. Complex systems may be instrumented with hundreds or thousands of sensors so that engineers can obtain a comprehensive view of nominal system operation and potentially risky diversions from nominal operation.

Some of these systems carry certain risks that must be mitigated during aircraft operation, such as when the aircraft is undergoing testing. Additionally, some of these systems are operated specifically during an initial test and/or to expand the system operation limits, such as by performing aircraft flight tests. Therefore, the aircraft systems must be monitored by a telemetry system, which gathers data from each system using telemetry data gathered from sensors associated with each system.

In order to monitor and control the system(s) under test, Responsible Engineers (REs) typically gather in a common or virtually common control room. In a control room setting, many REs monitor the telemetry data transmitted by the systems under test, with each RE focused on the details of his/her particular area of expertise. REs are highly trained, and their quick assessment of developing threats and rapid communication to operators of the systems under test directly and significantly enhance safe system operation. In such environments, time is a very scarce resource and slow telemetry data reception and/or slow RE action in response to non-nominal telemetry data during a critical phase of testing could lead to significant failures.

Accordingly, delays in routing telemetry through a telemetry visualization system can increase risk of significant failure. Current state of the art telemetry visualization systems first write telemetry data to a persistent storage component. Only after telemetry data is successfully written to a persistent storage component is that information made available for control room display terminals to query and display to REs. Because existing solutions require all data to first be stored before it can be displayed, the systems add a time delay, a potential layer of unpredictable delays, and/or potential software component failures that could prevent REs from seeing telemetry data in a more timely fashion.

### BRIEF DESCRIPTION OF THE DRAWINGS

Detailed descriptions of implementations of the present technology will be described and explained through the use of the accompanying drawings.

FIG. 1A schematically illustrates a computing system for processing measurands and communicating measurands to responsible engineering stations, in accordance with representative embodiments of the present technology.

FIG. 1B illustrates a partially schematic, isometric illustration of a representative aerospace system including an aircraft, in accordance with representative embodiments of the present technology.

FIG. 2 illustrates an example method of operation of a telemetry visualization system, in accordance with representative embodiments of the present technology.

FIG. 3 illustrates an example computing device of a telemetry visualization system, in accordance with representative embodiments of the present technology.

FIG. 4 illustrates an example configuration of a networked environment that includes computing devices of a telemetry visualization system, in accordance with representative embodiments of the present technology.

The technologies described herein will become more apparent to those skilled in the art from studying the Detailed Description in conjunction with the drawings. Embodiments or implementations describing aspects of the present technology are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

A control room is an environment in which one or more REs collaborate to observe, monitor, and/or control the operation of various systems under test. An RE is a control room participant having specific training and responsibilities for a focused part of control room operations, such as being an expert in navigation systems, an expert in aircraft aerodynamics, and/or an expert in other aircraft systems and/or components. A system under test refers to an instrumented system that is the focus of a particular test. The system under test emits or transmits telemetry data, which is recorded by various sensors integrated into the system. Accordingly, telemetry includes data (e.g., a stream of data readings) from various sensors monitoring the system under test. Telemetry can be communicated in any suitable manner of communication sufficient to reliably deliver the information, such as wired and/or wireless communication methods.

As used herein, a measurand refers to a telemetry sensor measurement having a specific value, a specified unit, a timestamp of when the measurement was captured, and/or other attributes associated with the sensor measurement. Measurands can be received in real or near-real time and/or stored in a persistent storage medium. Persistent storage refers to a non-volatile archive of digital information available for later retrieval or query.

A telemetry visualization system refers to a software and/or hardware solution that ingests telemetry data, such as raw sensor readings and/or measurands, analyzes the telemetry data, and presents visual, graphical and/or otherwise informational displays representing the system under test in ways to increase (e.g., maximize) the speed and accuracy with which REs comprehend new information in the control room.

While various implementations of the present technology discussed in this application relate to aircraft and aircraft systems under test, it is to be understood that in some embodiments, other fields of industry involving complex and potentially dangerous systems, such as industrial processing, large scale power generation, and/or other fields, can benefit from the described innovations of the present technology.

### Telemetry Visualization System

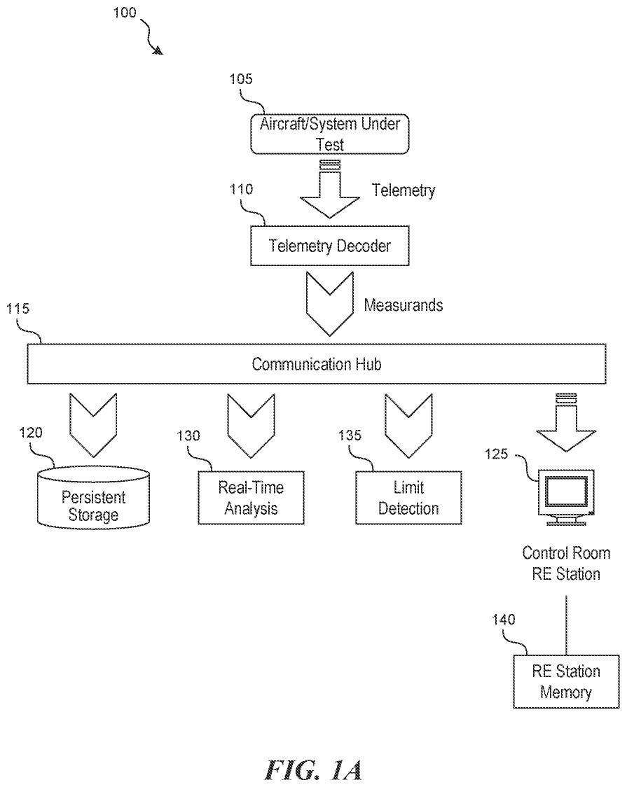

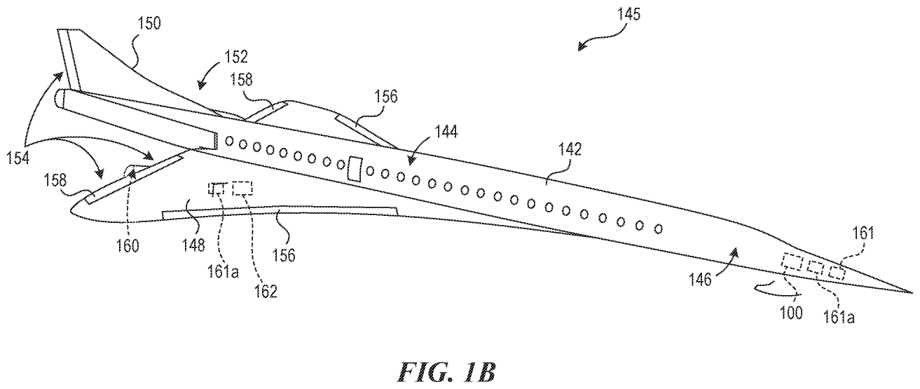

FIG. 1A illustrates a system 100 for monitoring an aircraft/system under test 105 (e.g., an aircraft and/or components of an aircraft). The system 100 is designed to reduce (e.g., minimize) software interactions between or among the actions of receiving telemetry data, decoding the data, and/or delivering the data to an RE display in the control room, in particular, as applied to software interactions that include measurands. To reduce (e.g., minimize) software interactions that include measurands, other processing tasks can be managed in concurrent or parallel processing streams in accordance with embodiments of the present technology.

As shown, components of the system 100 can include various modules, which can be hardware and/or software-implemented special-purpose modules that can include one or more processors, data storage media, memory device(s) and computer-executable instructions configured to perform various operations.

As shown, the illustrated system 100 can include a telemetry system decoder 110. The telemetry decoder 110 receives telemetry data from the aircraft/system under test 105, and the received data can include sensor readings, derived sensor data, and/or other telemetry data. The telemetry decoder 110 processes the received telemetry data to produce one or more measurands. A representative function of the telemetry system decoder 110 is to provide awareness, e.g., complete and detailed awareness, of how the communication medium encodes the telemetry. For communication efficiency, the encoded telemetry might bundle tens or hundreds of floating-point numbers into a single message. In this case the telemetry system decoder 110 can unpack each individual sensor measurement, e.g., each floating-point number in this example, and decode sensor identifiers into user-friendly names. In some implementations, the telemetry system decoder 110 constructs a measurand, and publishes it to the communication hub 115. In other cases, the telemetry message can be encoded in a proprietary or industry standard format (ARINC 429 for example), where collections of digital signals are decoded to arrive at a sensor reading, which can be a number. In some implementations, the telemetry system decoder 110 can further decorate a decoded sensor measurement with extra attributes, such as if a given reading was received out of order with respect to previously received measurands. In particular embodiments, the telemetry system decoder 110 can protect the entirety of all downstream parts of the telemetry visualization system from needing to contain any knowledge of how the telemetry data was encoded and transmitted.

The communication hub 115 receives the one or more measurands from the telemetry system decoder 110. The communication hub 115 then determines what other components in the system 100 are to receive each measurand. For example, the communication hub 115 can include a signal subscription list (e.g., a retrievably stored database, table, set of key-value pairs, virtual file, etc.), which designates various outbound data streams for different types of measurands. In some embodiments, the signal subscription list comprises a measurand identifier, descriptor, origination sensor identifier, sensor type and/or the like. In some embodiments, where a measurand is a composite value (e.g., an aggregation of readings generated by multiple sensors), the signal subscription list comprises a sensor group identifier. In some embodiments, the sensor group identifier is associated with a plurality of sensors based on a particular characteristic, such as part number, output type, geographical location, wireless gateway identifier, and/or the like. In some embodiments, the signal subscription list further comprises a target device identifier, such as a MAC address, an International Mobile Equipment Identity (IMEI) number, an International Mobile Subscriber Identity (IMSI) number, a unique equipment identifier associated with a transceiver coupled to the device (e.g., antenna, Bluetooth module), IP address, or another similar identification feature.

A particular device and measurand pair in a subscription list can be associated with an outbound data stream. For each designated outbound data stream associated in a subscription list with a particular measurand, the communication hub 115 can create a copy and/or duplicate reference of the measurand. The copy and/or duplicate reference is then sent by the communication hub 115 to a destination associated with each outbound data stream by concurrently and/or parallel processing the data. To accomplish this, the communication hub 115 can be (or can include) a computing device that has a plurality of computing cores for concurrent and/or parallel processing of measurands, outbound data streams, and/or other data processing actions. The internals of the communication hub 115 can be implemented in such a way as to avoid interrupting (e.g., never interrupt) the rate of flow of measurands through it. Any communication hub management operation that could take a variable amount of time, in some implementations, can utilize external parallel threads so as not to interrupt the flow of measurands. Once such parallel threaded activity is the management of the subscription list for each outbound data stream.

Additionally, some implementations can leverage knowledge that this part of the telemetry visualization system executes in an environment with sufficiently sized shared memory and, as such, can avoid making copies of measurands and rather generate memory-efficient pointers that indicate a memory location where a measurand is stored. As each measurand passes through the communication hub 115, copies of the memory location of the single measurand object (e.g., pointers) can be transmitted down each outbound data stream in order to reduce the bandwidth requirement of the outbound data stream. Furthermore, in such execution environments, each software component (120, 125, 130, 135) downstream of each data stream coming out of the communication hub 115 can execute via its own hardware execution thread, and all can read the single measurand object that passed through the communication hub 115 via a pointer. This shared access to each measurand object further speeds up the overall process by not increasing computer memory usage as the number of downstream components (120, 125, 130, 135) grows over the execution lifespan of the system.

One destination for an outbound data stream can be a persistent storage device 120. The persistent storage device 120 can receive the copy and/or duplicate reference (pointer) to the measurand from the outbound data stream and store the copy and/or duplicate reference to the measurand for later access or query. For example, after the aircraft/system under test 105 has been tested, measurands can be accessed from the persistent storage device 120 and analyzed to determine various system performance parameters, such as system performance over time, system performance with respect to tolerancing, system safety data, and/or other system performance parameters. Persistent storage devices 120 generally have irregular performance speeds based on their physical implementations, or devices having no moving parts may need to catalog or balance data storage over time. Rather than having this irregular performance speed impact all other parts of the telemetry visualization system, memory buffers can be utilized to smooth out persistent storage 120 device speed irregularities and only impact this single outbound data stream exiting the communication hub 115.

A second destination for an outbound data stream can be a control room RE station 125. In some implementations, the control room can include multiple RE stations 125. An individual RE station 125 can be (or can include) a computer terminal, a personal computing device, a mobile computing device, and/or another suitable computing device. The RE station 125 can receive a measurand from an outbound data stream and immediately or nearly immediately display the copy and/or duplicate reference of the measurand and/or a statistic, parameter, and/or value derived from the measurand to the RE associated with the RE station 125. Because this is done concurrently and/or in parallel with the storing operation of the copy and/or duplicate reference of the measurand, no time is lost waiting for the copy and/or duplicate reference of the measurand to be stored in the persistent storage device 120 before displaying the copy and/or duplicate reference of the measurand. Not only does this concurrent display enable REs to quickly observe any non-nominal measurands, but the concurrent display can also provide redundancy for measurand display should the persistent storage device 120 be malfunctioning and/or inoperable. In contrast, existing systems require that displayed measurands be accessed from the persistent storage device 120. If the persistent storage device 120 is malfunctioning and/or inoperable, such existing systems are unable to display the measurands to REs in the control room.

In a particular example, in some implementations, the communication hub 115 determines if the persistent storage device 120 is experiencing a malfunction and/or a failure that renders the persistent storage device 120 inoperable. While measurand data is still being delivered normally to the RE station 125, a notification and/or alert can be generated by the communication hub 115 and communicated via a separate outbound data stream to the RE station 125 indicating that measurands are not being stored in the persistent storage device 120. In some implementations, the communication hub 115 can also route measurand data via a separate outbound data stream to a backup storage unit, keep the measurand data in volatile memory in the communication hub 115 (e.g., cache the data for a predetermined period of time), indicate to the RE station 125 that the measurands are to be stored at the RE station 125 (such as RE station memory 140), and/or otherwise maintain or attempt to maintain some record of the lost measurands.

In some implementations, the communication hub 115 performs certain data processing functions concurrently and/or in parallel with transmitting copies and/or duplicate references of measurands. Such data processing functions can include real-time measurand analysis 130 and/or limit detection 135. For example, real-time measurand analysis 130 can include performing analysis on measurands at the communication hub as the measurands are received from the telemetry decoder 110 to obtain derived values from various measurands, obtain one or more operating parameters of the aircraft/system under test 105, and/or perform other data processing functions. In some implementations, the communication hub 115 can also send analysis to appropriate RE stations via a separate outbound data stream.

The communication hub 115 can perform limit detection 135 by comparing the received measurands from the telemetry decoder 110 to known system functionality limits of the aircraft/system under test 105. For example, a received measurand can be compared to a threshold maximum allowable value for the measurand. If the received measurand exceeds the threshold maximum allowable value, the communication hub 115 can take an action, such as by generating a separate outbound data stream to the appropriate RE station 125 indicating that the limit has been exceeded, which allows the RE at the RE station 125 to take cautionary, emergency, and/or corrective action.

Existing systems require that displayed measurands be accessed from the persistent storage device 120. If the persistent storage device 120 is malfunctioning and/or inoperable, such existing systems are unable to display the measurands to REs in the control room. Embodiments of the communication hub 115 described herein deliver the measurands to the REs in the control room even if the persistent storage device 120 is not functioning properly. The communication hub 115 can also perform data processing, such as real-time measurand analysis 130 and/or limit detection 135, parallel and/or concurrently with telemetry data reception and/or measurand transmittal to the multiple RE stations 125. In this way, measurands and/or derived values from measurands can be delivered immediately or nearly immediately to the REs at the RE workstations 125, even in situations where the persistent storage device 120 or other components of the system 100 fail to work properly.

### Aircraft

FIG. 1B shows a partially schematic, isometric illustration of a representative aerospace system including an aircraft 145 (e.g., a supersonic aircraft) in which, and/or with which, a telemetry visualization system configured in accordance with embodiments of the present technology can operate. The aircraft 145 includes a fuselage 142, which houses a passenger cabin 144 and flight deck 146. The passenger cabin 144 can be configured to carry any suitable number of passengers. In some embodiments, the passenger cabin 144 can be omitted and/or the aircraft 145 can be unmanned. The aircraft 145 can include one or more wings 148, a vertical stabilizer 150 (e.g., carried by an empennage 152 of the aircraft 145), and/or suitable flight control surfaces 154 carried by the one or more wings 148 and/or the vertical stabilizer 150 (e.g., a rudder), for aircraft stability and control. The flight control surfaces 154 can include slats 156 on the leading edge(s) of the wing(s) 148, flaps 158 on the trailing edge(s) of the wing(s) 148, and/or other flight control surfaces 154 (e.g., elevators, stabilizers, and/or elevons) suitable for aerodynamically controlling an aircraft during takeoff, climb, flight, approach, landing, and/or other activities. The aircraft 145 can further include one or more propulsion systems 160 configured to power the aircraft efficiently at supersonic and/or subsonic speeds.

The aircraft 145 can further include a telemetry system 161 (illustrated schematically) which can include telemetry components 161a such as systems, sensors, and/or instruments structured to detect and output information related to any suitable aspect of the aircraft 145, such as a configuration of a flight control surface 154, an airspeed, an altitude, location (e.g., via GPS), etc. The telemetry system 161 can include an analog-to-digital encoder structured to convert analog sensor signals to digital data. The telemetry system 161 can be communicatively coupled, via a network, to a telemetry decoder 110 structured to receive the digital data. In addition to including airborne-side telemetry components, the telemetry system 161 can include ground-side telemetry components. The telemetry system 161 can include a transmitter, such as a radio-frequency transmitter, which can be configured for low-range transmission of wirelessly collected data from the sensors to a gateway and/or directly to an on-board satellite antenna structured to transmit the collected data to remote computing systems, such as the telemetry decoder 110 of FIG. 1A.

The aircraft 145 can further include one or more fuel tanks 162 (illustrated schematically) for storing and distributing fuel for the aircraft 145. In some embodiments, one or more of the telemetry components 161a can include one or more fuel amount sensors to determine an amount (e.g., by volume and/or by weight) of fuel in the one or more fuel tanks 162 and/or one or more sensors suitable for determining the weight and/or balance of the aircraft 145 (which can further be used to determine a fuel weight). In general, one or more of the telemetry components 161a can include any suitable fuel amount sensors for determining, at any given moment and/or periodically, the amount of fuel in the one or more fuel tanks 162.

### Methods of Operation of a Telemetry Visualization System

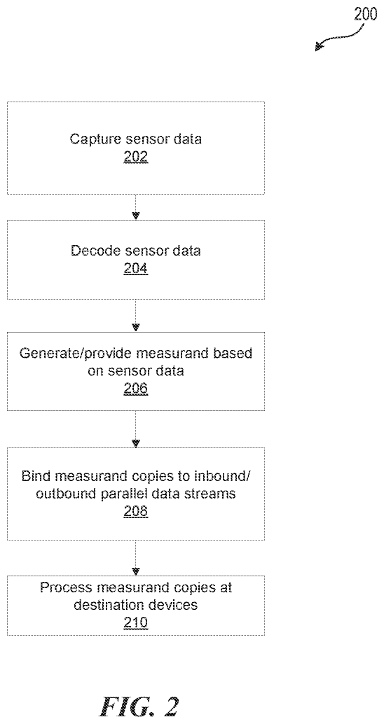

FIG. 2 illustrates an example method 200 of operation of a telemetry visualization system, in accordance with representative embodiments of the present technology. According to various embodiments, operations of method 200 can be performed by or via any suitable component, such as the telemetry decoder 110, communication hub 115, persistent storage 120, real-time analysis module 130, limit detection module 135, control room RE station 125, and/or control room RE station memory 140.

As shown, at 202, on-board and/or on-ground sensor data is captured by sensor and instrumentation components, such as those described in relation to FIG. 1B. The captured data can be converted (e.g., from analog to digital form), aggregated, and/or optimized for transition by a telemetry system 161. The captured data can be transmitted, by the telemetry system 161, via one or more networks, to a decoder, such as the telemetry decoder 110 of FIG. 1. In some embodiments, data is captured and transmitted in substantially real time. In some embodiments, data is transmitted periodically at suitable time intervals. In some embodiments, the transmitted data is encrypted. For example, the transmitted data can be encrypted by the telemetry system 161 using a private key from a public/private key, where a limited number of copies of public keys corresponding to the private key is distributed to a predetermined number of devices including, for example, the telemetry decoder 110. At 204, sensor data is received and decoded by the telemetry decoder 110. As part of decoding the data, the telemetry decoder 110 can decrypt the data using the public key.

At 206, the telemetry decoder 110 can generate and/or provide measurands as described, for example, in relation to FIG. 1A. For example, measurands can include optimized data, aggregated data, data sets where outliers have been removed, etc. Furthermore, measurands can be generated to include data bundles, such as a plurality of same-type sensor readings over a period of time, a plurality of readings for a group of sensors disposed in a particular location, etc. The generated measurands can be stored in persistent data structures. In some embodiments, the persistent data structures reside on a memory device accessible to both the source system (e.g., the decoder) and the destination system (e.g., the RE workstation). In some embodiments, the generated measurands are cached in shared memory and are removed from the shared memory after being accessed and included in a display feed by the destination device.

At 208, the measurands and/or measurand copies are associated with particular data streams. In some embodiments, the data streams are part of data interfaces embodied in computer-executable code that may include read/write operations, get/post operations, and/or the like. In some embodiments, the data streams are broadcast data streams associated with more than one destination device.

At 210, the communication hub 115 and/or destination devices can process the measurands. For example, a particular data stream can include items for a displayable data feed, and computer-executable instructions can be structured to generate charts, graphs, and/or similar visual representations of measurand data. In another example, measurands a particular data stream can be filtered by priority level. In another example, measurands in a particular data stream can be filtered by output destination (e.g., display, speakers, electronic message, background processing, etc.).

### Computer System

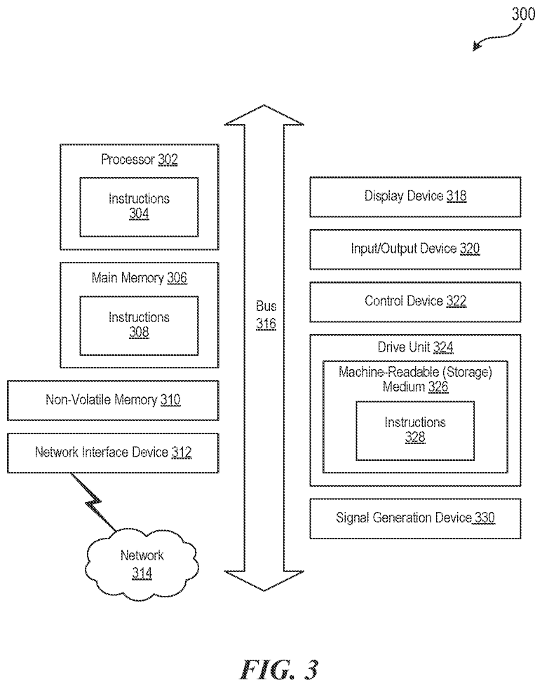

FIG. 3 is a block diagram that illustrates an example of a computer system 300 in which at least some operations described herein can be implemented. As shown, the computer system 300 can include: one or more processors 302, main memory 306, non-volatile memory 310, a network interface device 312, video display device 318, an input/output device 320, a control device 322 (e.g., keyboard and pointing device), a drive unit 324 that includes a storage medium 326, and a signal generation device 330 that are communicatively connected to a bus 316. The bus 316 represents one or more physical buses and/or point-to-point connections that are connected by appropriate bridges, adapters, or controllers. Various common components (e.g., cache memory) are omitted from FIG. 3 for brevity. Instead, the computer system 300 is intended to illustrate a hardware device on which components illustrated or described relative to the examples of the drawings and any other components described in this specification can be implemented.

The computer system 300 can take any suitable physical form. For example, the computer system 300 can share a similar architecture to that of a server computer, personal computer (PC), tablet computer, mobile telephone, game console, music player, wearable electronic device, network-connected (“smart”) device, AR/VR systems (e.g., head-mounted display), or any electronic device capable of executing a set of instructions that specify action(s) to be taken by the computer system 300. In some implementations, the computer system 300 can be an embedded computer system, a system-on-chip (SOC), a single-board computer system (SBC) or a distributed system such as a mesh of computer systems or include one or more cloud components in one or more networks. Where appropriate, one or more computer systems 300 can perform operations in real-time, near real-time, or in batch mode.

The network interface device 312 enables the computer system 300 to exchange data in a network 314 with an entity that is external to the computing system 300 through any communication protocol supported by the computer system 300 and the external entity. Examples of the network interface device 312 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 306, non-volatile memory 310, machine-readable medium 326) can be local, remote, or distributed. Although shown as a single medium, the machine-readable medium 326 can include multiple media (e.g., a centralized/distributed database and/or associated caches and servers) that store one or more sets of instructions 328. The machine-readable (storage) medium 326 can include any medium that is capable of storing, encoding, or carrying a set of instructions for execution by the computer system 300. The machine-readable medium 326 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 310, removable memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 304, 308, 328) set at various times in various memory and storage devices in computing device(s). When read and executed by the processor 302, the instruction(s) cause the computer system 300 to perform operations to execute elements involving the various aspects of the disclosure.

### Networked Computing Environment

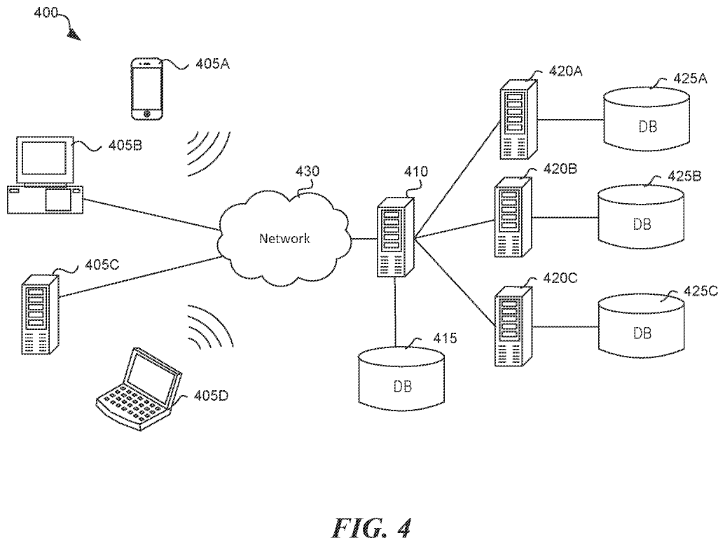

FIG. 4 is a system diagram illustrating an example of a computing environment in which the disclosed system operates in some embodiments. In some embodiments, environment 400 includes one or more client computing devices 405A-D, examples of which can host the components for FIG. 1A and/or 1B. Client computing devices 405 operate in a networked environment using logical connections through network 430 to one or more remote computers, such as a server computing device.

In some embodiments, server 410 is an edge server which receives client requests and coordinates fulfillment of those requests through other servers, such as servers 420A-C. In some embodiments, server computing devices 410 and 420 comprise computing systems, such as the provider computing system 108. Though each server computing device 410 and 420 is displayed logically as a single server, server computing devices can each be a distributed computing environment encompassing multiple computing devices located at the same or at geographically disparate physical locations. In some embodiments, each server 420 corresponds to a group of servers.

Client computing devices 405 and server computing devices 410 and 420 can each act as a server or client to other server or client devices. In some embodiments, servers (410, 420A-C) connect to a corresponding database (415, 425A-C). As discussed above, each server 420 can correspond to a group of servers, and each of these servers can share a database or can have its own database. Databases 415 and 425 warehouse (e.g., store) information pertinent to applications described herein, including input data, output data, and/or post-processing data, subscription lists, etc. Though databases 415 and 425 are displayed logically as single units, databases 415 and 425 can each be a distributed computing environment encompassing multiple computing devices, can be located within their corresponding server, or can be located at the same or at geographically disparate physical locations.

Network 430 can be a local area network (LAN) or a wide area network (WAN), but can also be other wired or wireless networks. In some embodiments, network 430 is the Internet or some other public or private network. Client computing devices 405 are connected to network 430 through a network interface, such as by wired or wireless communication. While the connections between server 410 and servers 420 are shown as separate connections, these connections can be any kind of local, wide area, wired, or wireless network, including network 430 or a separate public or private network.

### CONCLUSION

From the foregoing, it will be appreciated that specific embodiments of the disclosed technology have been described herein for purposes of illustration, but that various modifications may be made without deviating from the technology. For example, systems in accordance with some embodiments can be configured to run on a single processor and still gain the benefits of the memory size not increasing as the number of software components downstream of the communication hub 115 increases. In another example, a representative embodiment can still gain the benefits of protecting the optimized flow of measurands to RE stations 125, isolated from any slow components (120, 130, 135) downstream of the communication hub 115, even if downstream processing was delegated to separate computing environments and the outbound data streams were communicated across a network or other medium.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative embodiments may employ differing values or ranges.

The teachings of the technology provided herein can be applied to other systems, not necessarily the system described above. The elements and acts of the various examples described above can be combined to provide further embodiments of the technology. Some alternative embodiments of the technology may include not only additional elements to those embodiments noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112 (f) will begin with the words “means for,” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

I/We claim:

1. A communication hub computing system, the communication hub computing system comprising:
one or more processors; and
a computer-readable medium comprising instructions that, when executed by the one or more processors, cause the one or more processors to perform operations, the operations comprising:
receiving, from a telemetry decoder, a measurand associated with a system under test, wherein the measurand is generated based on a data item captured by at least one sensor associated with the system under test;
binding the measurand to two or more outbound data streams from a subscription list based on an identifier of the measurand, the two or more outbound data streams comprising an outbound data stream associated with a persistent storage device and an outbound data stream associated with a responsible engineer workstation;
generating a plurality of copies of the measurand, wherein a first number of copies of the measurand corresponds to a second number of outbound data streams,
wherein each of the plurality of copies of the measurand comprises a pointer to a memory location on a source computing device; and
for individual ones of the two or more outbound data streams, transmitting a respective copy of the measurand to a destination computing device associated with the corresponding outbound data stream.

2. The communication hub computing system of claim 1, wherein the outbound data stream maps to a display device, the operations further comprising rendering a visual representation of the measurand on the display device.

3. The communication hub computing system of claim 2, wherein the measurand in included in a measurand set, the operations further comprising:
determining measurands in the measurand set that are not required for human engineer consumption; and
segregating a portion of the measurand set corresponding to the determined measurand for parallel processing.

4. The communication hub computing system of claim 3, further comprising forgoing rendering the visual representation of the determined measurand segregated for parallel processing.

5. The communication hub computing system of claim 1, further comprising:
determining that a particular measurand corresponds to a background process;
generating a notification comprising the particular measurand; and
transmitting the notification to the responsible engineer workstation, comprising performing at least one of (1) generating an auxiliary data stream for the particular measurand or (2) causing the responsible engineer workstation to forgo including the particular measurand in a displayable data feed associated with the outbound data stream.

6. The communication hub computing system of claim 1, wherein the measurand comprises a bundle of sensor readings.

7. The communication hub computing system of claim 1, wherein the measurand comprises an attribute field indicative of an order of a related sensor reading relative to other sensor readings.

8. A computer-implemented method performed by a communication hub computing system, the method comprising:
receiving, from a telemetry decoder, a measurand associated with a system under test, wherein the measurand is generated based on a data item captured by at least one sensor associated with the system under test;
binding the measurand to two or more outbound data streams from a subscription list based on an identifier of the measurand, the two or more outbound data streams comprising an outbound data stream associated with a persistent storage device and an outbound data stream associated with a responsible engineer workstation;
generating a plurality of copies of the measurand, wherein a first number of copies of the measurand corresponds to a second number of outbound data streams, wherein each of the plurality of copies of the measurand comprises a pointer to a memory location on a source computing device; and
for individual ones of the two or more outbound data streams, transmitting a respective copy of the measurand to a destination computing device associated with the corresponding outbound data stream.

9. The method of claim 8, wherein the outbound data stream maps to a display device, the method further comprising rendering a visual representation of the measurand on the display device.

10. The method of claim 9, wherein the measurand in included in a measurand set, the method further comprising:
determining measurands in the measurand set that are not required for human engineer consumption; and
segregating a portion of the measurand set corresponding to the determined measurand for parallel processing.

11. The method of claim 10, further comprising forgoing rendering the visual representation of the determined measurand segregated for parallel processing.

12. The method of claim 8, further comprising:
determining that a particular measurand corresponds to a background process;
generating a notification comprising the particular measurand; and
transmitting the notification to the responsible engineer workstation, comprising performing at least one of (1) generating an auxiliary data stream for the particular measurand or (2) causing the responsible engineer workstation to forgo including the particular measurand in a displayable data feed associated with the outbound data stream.

13. The method of claim 8, wherein the measurand comprises a bundle of sensor readings.

14. The method of claim 8, wherein the measurand comprises an attribute field indicative of an order of a related sensor reading relative to other sensor readings.

15. One or more computer-readable media comprising instructions that, when executed by one or more processors, cause the one or more processors to perform operations comprising:
receiving, from a telemetry decoder, a measurand associated with a system under test, wherein the measurand is generated based on a data item captured by at least one sensor associated with the system under test;
binding the measurand to two or more outbound data streams from a subscription list based on an identifier of the measurand, the two or more outbound data streams comprising an outbound data stream associated with a persistent storage device and an outbound data stream associated with a responsible engineer workstation;
generating a plurality of copies of the measurand, wherein a first number of copies of the measurand corresponds to a second number of outbound data streams,
wherein each of the plurality of copies of the measurand comprises a pointer to a memory location on a source computing device; and
for individual ones of the two or more outbound data streams, transmitting a respective copy of the measurand to a destination computing device associated with the corresponding outbound data stream.

16. The media of claim 15, wherein the outbound data stream maps to a display device, the operations further comprising rendering a visual representation of the measurand on the display device.

17. The media of claim 16, wherein the measurand in included in a measurand set, the operations further comprising:
determining measurands in the measurand set that are not required for human engineer consumption; and
segregating a portion of the measurand set corresponding to the determined measurand for parallel processing.

18. The media of claim 17, further comprising forgoing rendering the visual representation of the determined measurand segregated for parallel processing.

19. The media of claim 15, the operations further comprising:
determining that a particular measurand corresponds to a background process;
generating a notification comprising the particular measurand; and
transmitting the notification to the responsible engineer workstation, comprising performing at least one of (1) generating an auxiliary data stream for the particular measurand or (2) causing the responsible engineer workstation to forgo including the particular measurand in a displayable data feed associated with the outbound data stream.

20. The media of claim 15, wherein the measurand comprises a bundle of sensor readings.
